(19) United States
(12) Patent Application Publication
(10) Pub. No.: US 2008/0298389 A1
(43) Pub. Date: Dec. 4, 2008

(54) INTRA-BODY COMMUNICATION NETWORK SCHEDULER AND METHOD OF OPERATION THEREOF

(75) Inventor: Rin Nagaike, Tokyo (JP)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/756,287

(22) Filed: May 31, 2007

(51) Int. Cl. H04L 12/24

(52) U.S. Cl. 370/468

(57) ABSTRACT

An intra-body communication network scheduler and method of operation thereof are provided. At a scheduler, network entities of an intra-body communication network are registered, which have raised interrupts to obtain the right to communicate data over the intra-body communication network. The network entities are queued at the scheduler in accordance with priorities of the network entities. The scheduler allocates the right to communicate data over the intra-body communication network during a next scheduling period to the next network entity in the queue.

The present invention relates to personal area network. In particular, the present invention relates to intra-body communication networks, communication techniques, scheduling requirements and use cases thereof

### BACKGROUND

Personal area networking will be an amazing future field of ambiguity networking. Developments in the field of personal area networking tries aspire interconnecting the broad number of electronic device, which are typically carried with a person. Such electronic devices include for instance wristwatch, pager, cellular telephone, portable music player, portable GPS receivers, personal digital assistant (PDA), and future portable electronic devices. Personal area networking is also applied for interlinking physiological sensor in personal preferably wearable systems including ECG sensors, eye movement sensors, gyroscopes, accelerometers, pulse oximeters, skin temperature and conductivity sensors and further physiological sensors. Such physiological sensor systems allow for collecting physiological information from each sensor equipped on the body of a person to be monitored (for instance suffering from an illness, while doing sports, while working under harmful environment conditions etc.) and storing/processing the collected physiological information at a host processing device.

In principle, networking functionality of personal area networks allows for new conveniences and networked services in that for instance specific functionalities of network device in the personal area network can be accessed via the personal area network, information provided by the network device can be gathered allowing for advanced services, I/O functionalities of different network device can be used for inputting/outputting information to the user in an adequate way and the like. The ability to share functionalities and data of individual network device among all others increases the usefulness of the individual network devices, providing features not possible with independent isolated devices.

Today's personal area networks use known data communication technologies for interlinking data interfaces of the electronic devices in a personal area network. Known data communication technologies are typically classified into wire-based and wireless data communication technologies. Wire-based interconnections of wearable portable electronic device are for instance well-known in the field of cellular telephones and portable electronic music players. A plurality of standardized and proprietary wire-based communication technologies are available and can be in principle used for personal area networks. While wire-based communication technologies are advantageous in view of power-consumption, eavesdropping, the laying of cables is cumbersome and lacks user-demanded flexibility and usability.

The aforementioned disadvantages of wire-based interconnection between portable electronic devices have for instance driven the development and improvement of low-power radio frequency technologies for data communication including for instance Bluetooth wireless communication standard, wireless local area network standards (various IEEE 802.xx standards), Wibree, Zig-Bee and the like. Typically, modern headsets of cellular telephones are connected through Bluetooth to the cellular telephone.

However, the disadvantages of wireless communication technologies are numerous.

Since a radio frequency based communication technologies irradiates into the space via antennas, any radio frequency communication is basically detectable by any third parties. Irradiation characteristics of the RF interfaces and antennas define the irradiation strength of the RF signals and irradiation direction. Whereas the irradiation strength may be compensated with the help of high sensitive receivers, directional irradiation characteristics are often undesired because for instance the irradiation direction is previously unknown, several irradiation directions are required in the network environment, or desired flexibility in the arrangement of the interconnected devices contradicts any predetermination of the irradiation direction.

Hence, any radio frequency based communication technologies, which uses substantially isotropic irradiation characteristics, has to be secured against criminals and malicious software eavesdropping the network communication. As a result, developers have to implement advanced security algorithm to protect network data communication. However, even the user of advanced security algorithms will not guarantee that malicious third parties will tap the network communication. Each improvement in security of data communication through a wireless network may moreover reduce the effective (net) data throughput.

The use of radio frequency communication technology may be also subjected to limited service space and time as well. In specific environments or under specific environment conditions, radio frequency based communication may not be used (for instance in medical institutions, air planes and the like) or may be subjected to interferences preventing from data communication (e.g. interference between a large number of radio frequency irradiating devices such as several interfering radio frequency based personal area networks operated by conference participants).

Finally, due to the substantial isotropic irradiation of radio frequency signals power consumption is a problematic topic for any radio frequency based wireless network. Since radio frequency based communication technologies basically has considerable higher energy consumption than wire-based communication technologies, it is a challenge for the developers to reduce power consumption in order to keep total running time at good level acceptable to the users.

Intra-body communication technology represents an advantageous technology for data communication in personal area networks comprising network devices, which are worn at the body. Inter-body communication technology makes use of physical body properties and characteristics, which allow for propagating physical signals between transceivers coupling to the body. The body of a person is used as a conductor for propagating such physical signals, which allow for coding digital data signals. Because intra-body communication does not irradiate radio frequency signals into space, eavesdropping of intra-body communication connects requires a physical interaction with the body conducting the intra-body signals. Such physical interaction will be hardly noticed by the person. The intra-body signals are conducted by the body and not irradiated isotropically, which significantly reduces the energy required for generating intra-body signals propagated by the body. Hence, intra-body communication technology possesses the advantages of wireless communication technologies in view of flexibility and usability while overcoming their principle deficiencies.

### SUMMARY OF THE INVENTION

The object basic to the invention is to provide for an improved signal scheduling, which take account of the specific properties of intra-body communication networks.

According to an aspect of the present invention, a method for scheduling data communication between network entities of an intra-body communication network is provided. At a scheduler network entities of an intra-body communication network are registered, which have raised interrupts inquiring right to communicate data over the intra-body communication network. The network entities are queued at the scheduler in accordance with priorities of the network entities. The scheduler allocates right to communicate data over the intra-body communication network during a next scheduling period to the next network entity in the queue.

According to an embodiment of the present invention, the network entities having same priorities are queued in a cyclic repetition scheme such that the right to communicate data over the intra-body communication network is allocated to that network entity out of the group of network entities having same priorities, which has waited for the longest time. This scheduling scheme substantially corresponds to round robin scheme.

According to an embodiment of the present invention, deadline periods of communication tasks to be performed by registered network entities are retrieved. The network entities are queued in accordance with the deadline periods.

According to an embodiment of the present invention, a set of communication resources is provided. The set of communication resources can be partially allocated to several network entities. A group of subsets of communication resources is formed from the total set of communication resources. The group of subsets of communication resources is allocated to a group of network devices at the same time and the right to communicate data over the intra-body communication network during the next scheduling period is allocated to the group of network devices having allocated the group of subsets of communication resources.

According to an embodiment of the present invention, the subsets of the groups of subsets of communication resources are formed in accordance with the priorities of the network devices of the group of network devices to which the groups of subsets of communication resources will be allocated.

According to an embodiment of the present invention, the priority of a network entity can be modified by the scheduler controlling scheduling of data communication over the intra-body communication network.

According to an embodiment of the present invention, the scheduling period can be modified by the scheduler controlling scheduling of data communication over the intra-body communication network.

According to another aspect of the present invention, a computer program product for scheduling data communication between network entities of an intra-body communication network is provided. The computer program product is stored on a computer-readable medium, which comprises program code, which when carried out by at a processing device, allows for performing the operations of registering network entities of an intra-body communication network having raised interrupts to obtain right to communicate data over the intra-body communication network; queuing the network entities in accordance with priorities of the network entities; and allocating right to communicate data over the intra-body communication network during the next scheduling period to the next network entity in the queue.

According to another aspect of the present invention, a scheduling module for scheduling data communication between network entities of an intra-body communication network is provided. The scheduling module comprises a registration component, which is configured for registering network entities of an intra-body communication network having raised interrupts to obtain right to communicate data over the intra-body communication network; a queue component, which is configured for queuing the network entities in accordance with priorities of the network entities; and an allocation component which is configured for allocating right to communicate data over the intra-body communication network during the next scheduling period to the next network entity in the queue.

According to another aspect of the present invention, a scheduling module for scheduling data communication between network entities of an intra-body communication network is provided. The scheduling module comprises means for registering network entities of an intra-body communication network having raised interrupts to obtain right to communicate data over the intra-body communication network; means for queuing the network entities in accordance with priorities of the network entities; and means for allocating right to communicate data over the intra-body communication network during the next scheduling period to the next network entity in the queue.

According to another aspect of the present invention, an intra-body communication network system comprising plural network entities; and a scheduling module for scheduling data communication between the network entities of the intra-body communication network is provided. The scheduling module comprises a registration component, which is configured for registering network entities of an intra-body communication network having raised interrupts to obtain right to communicate data over the intra-body communication network; a queue component, which is configured for queuing the network entities in accordance with priorities of the network entities; and an allocation component which is configured for allocating right to communicate data over the intra-body communication network during the next scheduling period to the next network entity in the queue.

### BRIEF DESCRIPTION OF THE DRAWINGS

These and other additional objects and features of the present invention will become readily apparent when the same are set forth in greater detail in the accompanying detailed description of the embodiments with reference being made to the drawings in which like reference numerals represent like or similar parts throughout and in which:

FIG. 1 shows schematically a first intra-body communication technique according to an embodiment of the present invention;

FIG. 2 shows schematically a second intra-body communication technique according to an embodiment of the present invention;

FIG. 3 shows schematically a block diagram of a principle implementation of a transceiver configured for intra-body communication according to an embodiment of the present invention;

FIG. 4 illustrates exemplary a block diagram of a personal area intra-body communication network according to an embodiment of the present invention;

FIG. 5 illustrates schematically a block diagram of a functional structure of a personal area intra-body communication network according to an embodiment of the present invention;

FIG. 6 illustrates an exemplary scheduling sequence on the basis of a first scheduling scheme according to an embodiment of the present invention;

FIG. 7 illustrates an exemplary scheduling sequence on the basis of a second scheduling scheme according to an embodiment of the present invention;

FIG. 8 illustrates an exemplary scheduling sequence on the basis of a third scheduling scheme according to an embodiment of the present invention;

FIG. 9 illustrates an exemplary scheduling sequence on the basis of a fourth scheduling scheme according to an embodiment of the present invention;

FIG. 10 illustrates a schematic box diagram of a scheduler according to an embodiment of the present invention;

FIG. 11a illustrates schematically a flow diagram of a master entity procedure according to an embodiment of the present invention;

FIG. 11b illustrates schematically a flow diagram of a network/slave entity procedure according to an embodiment of the present invention;

FIGS. 12a-c illustrate schematically further flow diagrams according to embodiments of the present invention; and

FIGS. 13a-b show schematically block diagrams of functional structures of personal area intra-body communication networks according to embodiments of the present invention.

### DETAILED DESCRIPTION OF THE INVENTION

The following embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. It should be noted that references to “an”, “one”, or “various” embodiments in this document are not necessarily to the same embodiment, and such references contemplate more than one embodiment.

This document discusses, among other things, intra-body communication technologies and data communication protocol framework thereof The data communication protocol framework in particular relates to scheduling of data communication within an intra-body communication network to prevent interference between data communications originating from different network devices at the same time.

[Transmission Techniques for (Intra-) Body Communication]

As aforementioned, intra-body communication technology makes use of physical properties of a body, which is able propagates physical signals between a signal simulating transmitter and a signal detecting receiver. In the following, different technologies enabling intra-body communication according to embodiments of the present invention will be discussed.

[Ultrasonic Signal Propagation through Bones]

Bones of a body are in principle capable for conducting mechanical vibrations due to their physical structure and properties. The ability of conducting and propagating mechanical vibrations can be used for signal generation at a transmitter, transmission between transmitter and receiver and signal detection at the receiver. A coding scheme making use of the properties of mechanical vibration allows for coding digital information (data) on the basis of mechanical vibrations.

According to an embodiment of the present invention, acoustic couplers on transmitter and receiver side may be used, which are able to generate acoustic waves, which are couple on the body surface through the skin into a bone. The bone is excited by the acoustic waves to vibrate substantially at the frequency of the acoustic wave. The vibration of the bones propagates along the bone and along bones through joints. The vibration of a bone excited by an acoustic coupler can be detected by the means of another spaced acoustic coupler, which senses the vibration of the bone on the surface of the body through skin. It should be noted that vibrations may be more easily coupled into bones and sensed thereat, when the bones are situated nearby the skin having interposed tissue of less thickness.

Such an acoustic coupler includes one or more acoustic transducers or an array of acoustic transducers, which convert electrical energy to mechanical vibrations, which can excite air, fluids and matter bulks having elastic properties to propagate density and/or sheer waves. Typically, density waves as known from acoustic waves propagated through air are excited by an acoustic transducer, which exciting surface is coupled to a matter bulk, i.e. the surface of the body. The acoustic transducer may be attached to the skin of the body such that intra-body acoustic communication can be performed using the body and bones as the communication medium. In the following, the vibrations excited by the means of the aforementioned transducers will be referred to acoustic signals or acoustic waves, which should not be understood as limiting the scope of the present invention to any specific interpretation of these terms.

The acoustic waves usable for intra-body communication purposes include audible and ultrasonic frequencies. The lower bound of the frequencies used may be chosen based on considerations of person's audio perception of the acoustic signals and the design constraints of acoustic transducers, and the upper bound of frequency range is chosen based on considerations of absorption of the acoustic signals and the directionality of acoustic transducers in transmitting and receiving acoustic signals. If for instance frequencies used for intra-body communication is selected out of the audible frequency range, i.e. substantially in the range from approximately 20 Hz to 20 kHz, an acoustic/vibration signal propagated through bones may reach the cochlea of the ear. Such an acoustic/vibration signal may be perceived by a person as an annoying noise. To prevent the perception of annoying noise, acoustic waves having frequencies in the range of ultrasonic may be preferable.

Size of the acoustic transducer, stiffness of the surface to which the transducer is attached and whether the transducer is to operate in resonance are among other constraints to be considered in selecting the operating frequencies. Tissue absorption of acoustic energy generally increases with the frequency of the acoustic signal, making acoustic intra-body communication less energy-efficient at higher frequencies. Frequencies up to 5 MHz should be applicable for intra-body communication.

An acoustic transducer may include one or more piezoelectric transducers. A piezoelectric transducer is made of piezoelectric material such as a piezoelectric ceramic, which is excited for thickness variations upon application of an electric potential. An acoustic transducer may include a plurality of acoustic transducers each being a piezoelectric transducer; in particular the plurality of acoustic transducers includes a micro-electromechanical acoustic transducer array. The acoustic transducer may be a substantially omni-directional acoustic transducer (having a substantially omni-directional characteristic for exciting and/or detecting acoustic signals) or a directional acoustic transducer (having a directional characteristic for exciting and/or detecting acoustic signals). Directionality of an acoustic transducer can be obtained by the use of an acoustic transducer array, which acoustic transducers thereof can be individually controlled allowing for instance for phase shifting the operation of the acoustic transducers in the array. The acoustic transducer may include a cavity and/or a diaphragm, which can be attached to the surface of the body. In order to increase the efficiency and sensitivity, the acoustic transducers may be operated at a resonance frequency or in a range near the resonance frequency. Resonance occurs at a primary frequency and its harmonic frequencies, thus a number of frequencies can be used when maximum efficiency and sensitivity is sought for.

The acoustic signals used for intra-body communication may be modulated onto a carrier frequency, which may be within an ultrasonic frequency range. The carrier frequency should be chosen to avoid using an acoustic signal audible to a person.

According to an embodiment of the present invention, signal discrimination may be obtained by varying acoustic signal frequencies. For example, a set of 16 different frequencies fₙ, n=0 to 15, (or frequency bands) may be used for coding 4-bit sequences. In general, a set of 2^{j} different frequencies fₙ, n=0 to j−1, may be used for coding n-bit sequences. More generally, the number basis has not to be limited to 2 or a multiple thereof The input bit stream may be converted to any other number basis, which enables the use of further sets of different frequencies. With respect to the aforementioned embodiment using 16 different frequencies, following the coding may use following frequency table associating frequencies and 4-bit sequences:

| Frequency | bit sequence |
|---|---|
| f₀: | 0000 |
| f₁: | 0001 |
| f₂: | 0010 |
| f₃: | 0011 |
| | . |
| | . |
| | . |
| f₁₄: | 1110 |
| f₁₅: | 1111 |

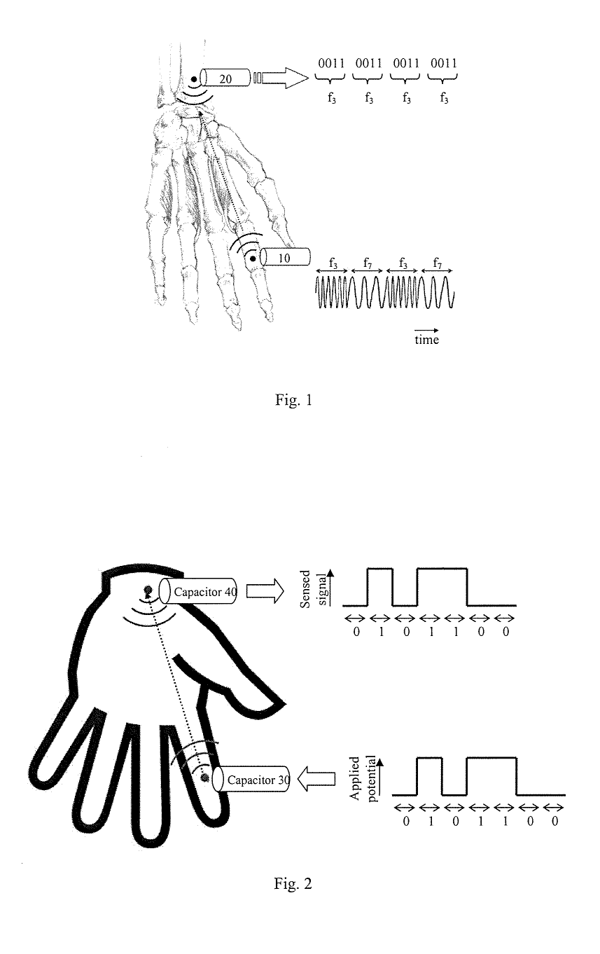

FIG. 1 illustrates a schematic intra-body communication comprising two transducers 10 and 20. A sequence of bits is streamed to the transmitting transducer 10. The bit stream is partitioned into 4-bit sequences, which are assigned to one of the frequencies defined above. The transmitting transducer 10 then excited acoustic signals having in particular a predefined length in time, which are coupled into the body and propagated through the next one or more bones located nearby the transmitting transducer 10. The acoustic signals are propagated through the one or more bones and the receiver transducer 20 senses the acoustic signals propagated through the bones next to the receiving transducer 20. The frequencies of the sensed acoustic waves are determined and 4-bit sequences are generated in accordance with the determined frequencies. The 4-bit sequences can then be composed to a reconstructed bit stream which corresponds to the bit stream supplied to the transmitting transducer 10.

In addition to the aforementioned frequencies enabling signal discrimination, one or more further frequencies may be defined and used for transmitting control information required for intra-body communication and in particular required for controlling inter-communication between several transducers forming an intra-body communication network.

Due to signal attenuation, the propagation distance of intra-body communication signals and in particular the propagation distance of acoustic signals at ultrasonic frequencies, may be limited. In order to overcome any distance limitations, one or more signal repeating transceivers may be arranged between transmitter and receiver. A signal repeating transceiver may detect the intra-body communication signals, reconstruct the digital information carried by the intra-body communication signals and again generates “new” intra-body communication signals from the reconstructed digital information.

[Electric Conductivity of Body Surface]

The human body is made up of material that can conduct electricity. Hence, according to an embodiment of the present invention, the human body may be used as a line for conveying a weak electrical signal. However, the electricity that travels through the human body is intrinsically weak such that specific electric transmitters and receivers adapted to the conductivity properties of the human body. In principle, an electric transmitter for intra-body communication can capacitively couple to an electric receiver for intra-body communication.

On transmitter side, a LC oscillator can for instance be used for generating a sine wave signal in the body. The LC oscillator capacitively couples to the body such that a sine wave signal (in accordance with the oscillator frequency) is generated in the body close to the coupling transmitter. Alternatively, a capacitor may be used for generating an electric potential in the body. A varying transmit voltage, i.e. a varying voltage at the capacitor or in the LC oscillator, can be used for coding digital information. The varying transmit voltage results in a varying electric potential coupled into the body. In particular, the transmit voltage may be varied by on-off keying such that the electric potential is either generated or not. On receiver side, a resulting displacement current, which is propagated through the body in response to the generated electric potential by the transmitter, can be sensed by the means of a current amplifier.

FIG. 2 illustrates a further schematic intra-body communication comprising two electric transceivers 30 and 40. A sequence of bits is streamed to the electric transceiver 30. The bit stream control keying on and off of a surface mounted inductor applying a voltage to the surface of the body resulting in a displacement current propagated through the skin and tissue of the body. This displacement current is sensed by a current amplifier comprised by the receiving electric transceiver 40. The sensed displacement current can be sampled by the means of an analog-to-digital converter, which sampling values enable for reconstructing individual bits in accordance with the on-off keying frequency applied on transmitter side. The individual bits are then composed to a reconstructed bit stream which corresponds to the bit stream supplied to the electric transceiver 30. Although the signal discrimination is not as high as illustrated with reference to acoustic signal intra-body communication, the discrimination periods, i.e. the periods during which generated transit signal has to persist to allow for detection, can be very short, when using the aforementioned electric intra-body communication. In order to allow for frequency determination of an acoustic signal, the acoustic signal is required to have a constant frequency over a predetermined period. Otherwise, the frequency determination must fail.

[General Transceiver Arrangement]

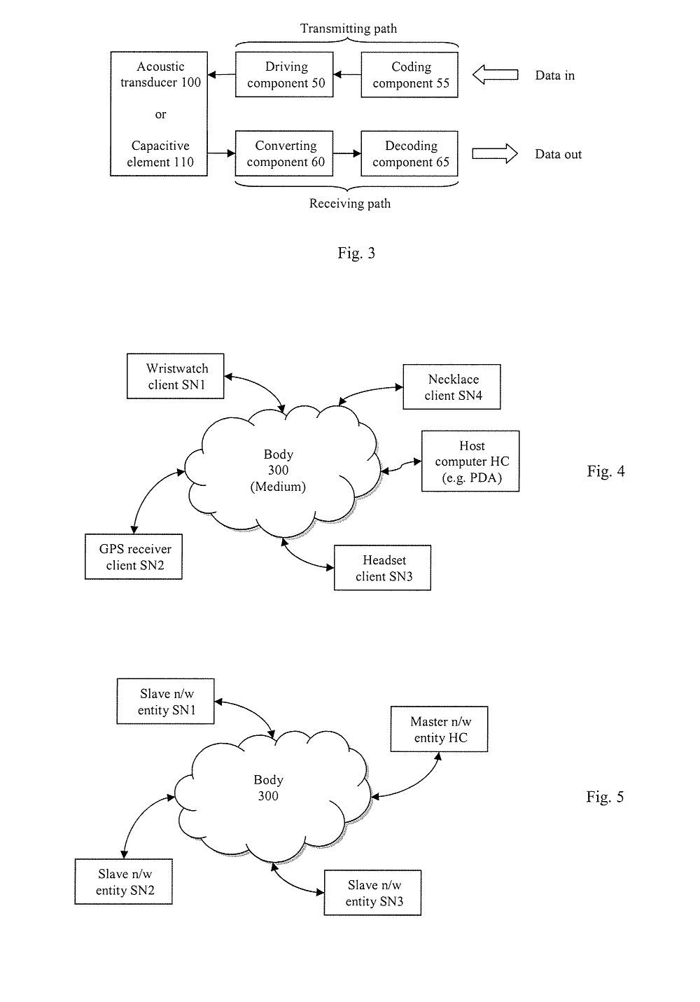

According to a general embodiment of the present invention, an inter-body communication transceiver such as schematically illustrated in FIG. 3 comprises transmitting section, a receiving section and the intra-body communication signal generator and detector.

The transmitting section receives data in form of for instance a bit stream, which is supplied to the coding component. The coded transmit signal generated by the coding component 55 is provided to a driving component 50 (such as an amplifier, frequency generator and the like), which drives the body coupling transmitting element. In case of acoustic signal intra-body communication, an acoustic transducer is driven in accordance with electric signals having frequencies in accordance with the bit sequence to frequency assignment table. The transducer generates acoustic waves having the desired frequency, which acoustic waves are coupled into the body. In case of electric signal intra-body communication, an electric signal of the driving component is supplied to the LC oscillator or capacitor, which capacitively couples to the body. Herein the coding component may generate an on-off keying signal to be supplied to the driving component in accordance with the input bit stream.

The receiving section comprises a detector, which senses the signals used for intra-body. In case of acoustic signal intra-body communication, an acoustic transducer is excited to vibrate by the acoustic signals propagated through the body. The vibrating acoustic transducer generates a corresponding electric signal, which frequency is determined. The determined frequency is then supplied to the decoder, which generates a bit sequence in accordance with the determined frequency. In case of electric signal intra-body communication, a displacement current is sensed by the means of a sensitive current amplifier. The sensed value is amplified and sampled.

This means a converting component 60 processes the signal generated by the receiver/detector. The resulting signal of the converting component 60 is then provided to the decoding component 65, which reconstruct the bit stream corresponding to the bit stream originally supplied for transmission.

[Intra-Body Communication Network]

From component point of view, an intra-body communication network may comprise various different wearable electronic devices including for instance wristwatch, pager, cellular telephone, portable music player, portable GPS receivers, personal digital assistant (PDA), identification badges, belt or waist packs, shoe inserts, physiological sensors and the like. For instance, the wristwatch may be a natural location for a display, microphone, camera and speaker. A waist pouch can carry a PDA, cellular telephone, keypad or other devices that are relatively large and heavy. Physical sensors can provide medical monitoring for such bodily functions as heartbeat, blood pressure, oxygenation, respirator rate. Pants packets are a natural location for wallet-based network devices to store information and identify the possessor. Shoe inserts can be self-powered and provide a data link to remote personal area network devices located in the environment such as workstations, access points and floor transponders that detect the location and identity of people.

From network implementation point of view, the communication between plural network devices of the intra-body communication network has to be enabled. Principle intra-body communication techniques are detailed described above. The intra-body communication techniques allow for one-to-one communication. However, intra-body communication techniques does not allow for data multiplexing because the transmission medium, i.e. the network infrastructure, is shared among the interconnected network devices. The communication of plural of intra-body communication enabled devices participating in an intra-body communication personal area network has to be managed. In this case, a scheduler has to be arranged in the intra-body communication network, which exercises control over the communication in the network.

From a functional point of view, the intra-body communication network implementation comprises a master network (n/w) entity HC and several slave network (n/w) entities SNi. A schematic illustration of the functional view of the intra-body communication network is depicted in FIG. 5. The operation of the scheduler, which is arranged with the master network entity HC will be described in the following in more detail.

[Scheduling Methods]

According to the present application, different scheduling schemes operable with the aforementioned body communication network should be presented.

Scheduling is in general a process of assigning tasks to a set of resources. Herein, the tasks to be assigned are given by data communication over the intra-body network and the set of resources is given by the communication resources of the intra-body communication network infrastructure.

In principle scheduling schemes, which will be described below takes account of the fact that intra-body communications making use of one or more of the aforementioned properties of the human body shares the same physical transmission medium (i.e. the human body) among all network entities of the body communication network. Hence, the communication resources of the shared common network infrastructure (i.e. the human body) which are provided to the body communication network have to be shared accordingly among the network entities allowing them for one-to-many communications. According to the present invention, scheduling of the communications of the networks entities enables aforementioned one-to-many communications.

Control over the scheduling of the network communications should be exercised by the means of a master entity, which is typically the host entity in the network (i.e. that network entity having enhanced computing capability). The scheduling functionality may be realized on the basis of a scheduler, which may be a hardware and/or software based component, comprised by the master entity enabling the master device for controlling communication activities of the slave entities (slave network nodes) in accordance with one or more scheduling schemes operated at the scheduler.

The scheduling schemes will be presented in the following on the basis of two fundamental scheduling concepts according to the present invention. However, those skilled in the art will appreciate on the basis of following description that the presented concepts are given on the basis of non-limiting examples. Moreover, although the scheduling concepts are describes as fundamental types those skilled in the art will also appreciate that different embodiments of the two fundamental scheduling concepts can be combined to obtain more sophisticated and expedient scheduling scheme.

[Time Domain]

One of the fundamental scheduling concepts is operable in the time domain and allows for time domain scheduling. For the sake of explanation, following assumptions should be considered. All slave entities of the intra-body communications network should be time-synchronized, each network entity has assigned by the scheduler of the master entity a “time slice” or time quantum, during which the network entity is allowed for communications over the intra-body communications network, and the communication resources should be in principle provided to that network entity, which is currently allowed for communication. The communication of the network slave entity includes in particular communication to the host entity, which means communication into any of upload and download direction; i.e. communication originating at the network slave entity and terminating at the host entity and communication originating at the host entity and terminating at the network slave entity. However, the general term “network communication” should not be understood as being limited to communications with the host entity and any other specific network entity. The network slave entity, which is currently allowed for communication may likewise communicate one-to-one to anyone of the network entities or one-to-many to several network entities thereof

[Time Domain Round Robin Scheduling]

According to an embodiment of the present invention, the scheduler of the master entity may reserve aforementioned time slots for the slave entities in a round-robin scheduling scheme. Round robin scheduling scheme means that the scheduler assigns time slots to the slave entities in substantially equal portions and order, handling the communications of all slave entities as having the same priority. Referring to FIG. x1, the master entity reserves the communication resources of the shared common network infrastructure to each of the slave entities and allocates the “right to communicate” to that slave entity, which turn it is.

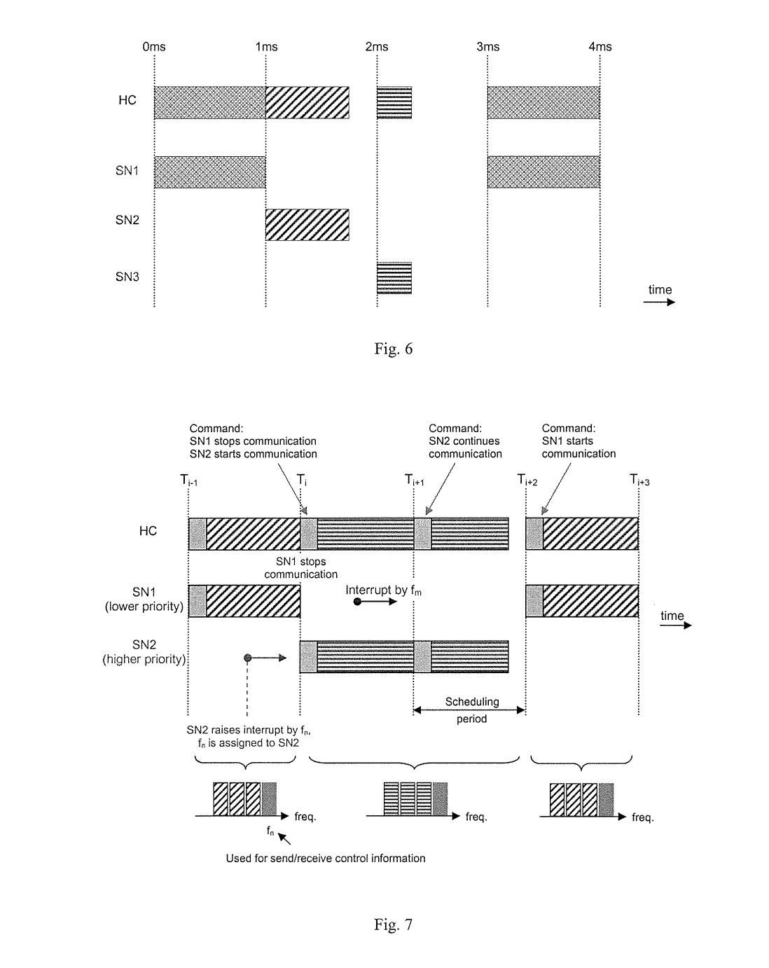

In the embodiment illustrated in FIG. 6, each time slot has a length of 1 ms (millisecond) and the intra-body communications network includes a master entity HC and three slave entities SN1 to SN3 participating in the scheduling scheme. As stated above, an all-to-many communication condition should be scheduled. The round robin scheduling scheme lets slave devices SN1 to SN3 take over allowance for communication on the shared common network infrastructure, i.e. the human body, in a periodically repeated (and preferably predefined) order, herein for instance SN1, SN2 and SN3. A scheduling cycle of round robin is completed once all slave entities in the order of the scheduling scheme have been allowed for communicating over the intra-body communication network. The periodically repeated order in which the round robin scheduling scheme is performed guarantees that the slave entity that has waited for the longest time for communicating, will be the next to be allowed for communicating; i.e. the right for communication is handed over to that slave entity, which has not been allowed for data communication in the current scheduling cycle.

Round robin scheduling scheme is adequate if the amount of data to be communicated is substantially the same. However, in case the amount of data to be communicated with the different slave entities differs, round robin scheduling scheme may result in time periods, in which the intra-body communication network is used although data is present to be communicated with one or more slave entities. But, the implementation of round robin scheduling scheme is in particular advantageous to slave entities having less complexity and economical power consumption, which allows for lightweight and small-sized (or tiny-sized) slave entities.

[Time Domain Preemptive Scheduling]

In general, a scheduling scheme is called non-preemptive if once right to communicate has been given to one of the slave entities in the intra-body communication network it cannot be taken away from that slave entity. The embodiment of the above illustrated round robin scheduling scheme can be classified as a non-preemptive scheduling scheme.

In preemptive scheduling schemes, the right to communicate, which is once given to a slave entity, can be taken away prioritizing data communication with another slave entity. According to an embodiment of the present invention, each network entity has assigned a priority as attribute. The priority attribute of a network entity may be predefined, may be assigned by the master entity or may be altered by the network entity itself in accordance with currently performed application. Again, a basic quantum of time or “time slice”, during which one of the slave entities has the right to communicate. The right to communicate is allocated to that slave entity, with which data to be communicated is present. In case of competing situation, where data portions to be communicated with two or more slave entities are present, priorities of the slave entities are considered and the slave entity having the highest priority is given the right to communicate. A slave entity having a lower priority stops communication of data in response to a higher prioritized slave entity has indicated its desire for data communication. The currently highest prioritized slave entity has to right to communicate data until completing (provided that a yet higher prioritized slave has not indicated inquiry of data communication).

In case several equally prioritized slave entities have indicated their inquiry of data communication, the scheduler of the master entity gives the right to communicate to those equally prioritized slave entities in a periodically repeated order for instance like round robin scheduling scheme.

The basic preemptive scheduling scheme according to an embodiment of the present invention will be more fully understood when referring to FIG. 7. In FIG. 7, a master entity including the scheduler responsible for preemptive scheduling in the intra-body communication network and a first slave entity SN1 having assigned lower priority and second slave entity SN2 having assigned higher priority are illustrated. The basic quantum of time or “time slice”, during which the right to communicate is let to one of the slave entities in the network is illustrated as HC scheduling period having for instance a predefined length in time equal Tᵢ₊₁−Tᵢ (where i is an integer value).

In the first scheduling period lasting from Tᵢ₋₁, to Tᵢ, the first slave entity SN1 currently communicates data. The second slave entity SN2 requests right to communicate data over the intra-body communication network. The slave entity SN2 may raise an interrupt signal to indicate the request for right to communicate.

Upon detection of the interrupt signal raised by slave entity SN2, the right to communicate is taken from slave entity SN1 because the requesting/interrupting slave entity SN2 has a higher priority in relation to the currently communicating slave entity SN1. This means that the slave entity SN1 currently communicating data is allowed for communicating up to the end of the current scheduling period (up to the moment in time Tᵢ, in particular not including Tᵢ)

Each scheduling period may comprise at least one sub-period of time, during which control information are exchanged among network entities including in particular scheduling instructions. One sub-period is preferably arranged at the beginning of the scheduling period. Further sub-periods for exchanging control information may start at predefined moments in time during the scheduling period and/or may be arranged at the end of the scheduling period. Each network entity may be allowed for issuing control information during the at least one sub-period; i.e. the network entities may issue control information in a predefined order. One or more sub-periods may be reserved exclusively to the scheduler.

The scheduling instructions comprise for instance a stop command instructing slave entity to stop (or to interrupt) data communication, a start command instructing a slave entity to commence (or continue previously interrupted) data communication, a continue command instructing a slave entity to continue previously commenced data communication and the like. Further control information may include for instance priority assignment, time-synchronization, announcement and/or negotiation of the responsible scheduler (upon setting the intra-body communication network into operation and if for instance several network entities in the intra-body communication network have schedulers), re-setting of length of the scheduling period and the like.

In the second scheduling period lasting from Tᵢ to Tᵢ₊₁, the first slave entity SN1 stops or interrupts communication of data and in accordance with the right to communicate passed now to the second slave entity SN2, the second slave entity commences data communication over the intra-body communication network. In the third scheduling period lasting from Tᵢ₊₁ to Tᵢ₊₂, the second slave entity SN2 continues data communication over the intra-body communication network until the data communication with the second slave entity SN2 is completed or a slave entity having a higher priority than the second slave entity SN2 requests for right to communicate data over the intra-body communication network (i.e. raises an interrupt).

For instance, the first slave entity SN1 having lower priority than priority level of the second slave entity SN2 raises an interrupt during the second scheduling period (from Tᵢ to Tᵢ₊₁). Upon detection of the interrupt raised by the first slave entity SN1 by the scheduler of the master entity HC, the scheduler compares the priorities of the interrupting slave entity (i.e. slave entity SN1 in this example) and the slave entity, to which right to communicate is currently allocated (i.e. slave entity SN2 in this example). As a result of this comparison, the right to communicate data remains by the first slave entity, which still has the higher priority and which continues data communication over the intra-body communication network for at least one more scheduling period.

In the fourth scheduling period lasting from Tᵢ₊₂ to Tᵢ₊₃, the second slave entity SN2 has complete data communication over the intra-body communication network. Hence, the communication resources of the network are available for allocation to another slave entity. As stated above, the lower prioritized first slave entity SN1 has already raised an interrupt requesting for allocating right to communicate data of itself (i.e. the first slave entity). This interrupt has been detected and registered by the scheduler of the intra-body communication network. Because the second slave entity SN2 has complete data communication and there has not been detected any interrupt of a higher prioritized slave entity (i.e. having a priority being higher than that of first slave entity SN1) the scheduler passes the right to communicate data to the second slave entity SN2, which then communicates over the intra-body network during the fourth scheduling period (from Tᵢ₊₂ to Tᵢ₊₃).

As illustrated with reference to acoustic signal intra-body communication technique, a set of frequencies may be used for signal discrimination. The possibility of using different frequencies for signal discrimination may also allow for making use of one or more frequencies for transmitting control information over the intra-body communication network in parallel to the data communication transmission.

This means that in alternative or in addition to the allocation of one or more sub-periods used for exchanging of control information and/or scheduling information among network entities one or more frequencies may be allocated for exchanging control information and/or scheduling information among the network entities and in particular with the scheduler at the master entity. The use of additional frequencies may be advantageous because the throughput of the data communication over the intra-body communication network is not effected by the exchange of control/scheduling information.

[Time Domain Earliest Deadline First]

In another embodiment of the present invention, a dynamic scheduling scheme and in particular a dynamic preemptive scheduling scheme is provided. The right to communicate data over the intra-body communication network is allocated by the scheduler of the master entity (HC) to network entities (in particular slave entities SN) in accordance with a priority queue.

To enable dynamic scheduling whenever data to be communicated is present a scheduling event is queue at the scheduler, which queuing considers a deadline, which defines a moment in time at which the communication task has to be completed or a period of time, during which the communication task has to be completed. In this embodiment, deadline should be understood as the latter definition, i.e. deadline time period.

Further, each network entity may regularly communicate data over the intra-body communication network. This means that the network entities should have allocated a (pre-) defined communication period of time T_{C} for communicating a complete set of data at a (pre-) defined repetition period T_{R}. Each of the communication period T_{C} and the repetition period T_{R} may be individual differing periods. This means that each network entity/slave entities SNi should have allocated right to communicate data for an individual communication period T_{Ci} at an individual scheduling repetition period T_{Ri}.

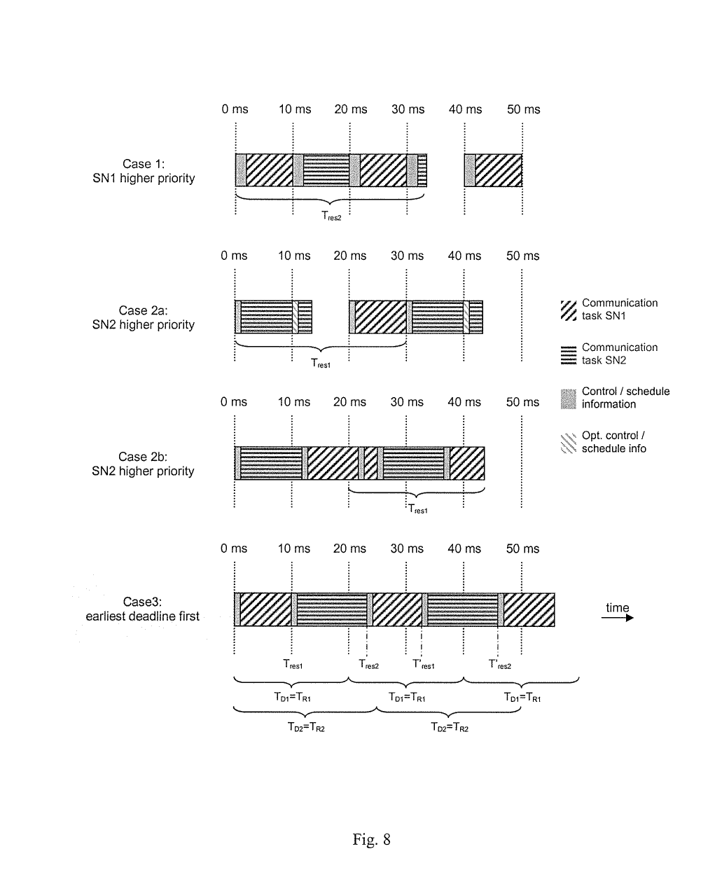

For the sake of a complete understanding, reference should be given to FIG. 8 illustrating an example communication scheduling flow of this embodiment of the present invention. The first slave entity SN1 should be allowed to make use of an individual communication period T_{C1}=10 ms (T_{C1}: communication period of slave entity SN1) for communicating data over the intra-body communication network within an individual repetition period T_{R1}=20 ms. The second slave entity SN2 should be allowed to make use of an individual communication period T_{C2}=12 ms (T_{C2}: communication period of slave entity SN2) for communicating data over the intra-body communication network within an individual repetition period T_{R2}=25 ms.

Earliest deadline first scheduling scheme, which can be classified as a dynamic preemptive scheduling scheme, considers among others arrival time of indications requesting data communication tasks, execution requirements of the communication tasks and deadline of the communication tasks when scheduling the different data communication tasks of network entities. The earliest deadline first scheduling scheme results in scheduling plan for allocating rights to communicate data such that all communication tasks are completed by their deadlines provided the overall data communication rate is sufficient high to principally work off all communication tasks within their deadlines.

According to an embodiment of the present invention, the aforementioned earliest deadline first scheduling scheme may be implemented on the basis of a normal preemptive scheduling scheme as described above. This means that the basic scheduling carried out at the scheduler of the master entity (HC) in the intra-body communication network on the basis of priority attributes assigned to the slave entities SN participating in the scheduling process. Deadlines are assigned as further attributes to the network entities/slave entities. The deadline attribute of a network entity may be predefined, may be assigned by the master entity or may be altered by the network entity itself in accordance with currently performed application. The earliest deadline first scheduling scheme according to the embodiment of the present invention considers both the priority attributes and the deadline attributes for controlling the sequence of allocations of right to communicate data. In particular if there has a slave entity a deadline, which is shorted than another slave entities competing for right to communicate data, a higher priority would be conceded to that slave entity having the shorter deadline even this slave entity has a priority lower than the competing slave entities. Hence, a trade off of both the priority and the deadline is considered to determine an effective priority, which determines the scheduling sequence of allocations of right to communicate data to the slave entities. As discussed in more detail below with reference to example case 3 illustrated in FIG. 8, the scheduler allocates right to communicate data with respect to predefined scheduling periods, defining the start and end of scheduled communication of a network entity having allocated right to communicate. In order to improve the efficient use of the communication resources, the duration of a scheduling period may be adapted to the scheduling scheme operated at the scheduler.

With reference to FIG. 8, a comparison of the basic preemptive scheduling scheme and the earliest deadline first scheduling scheme according to embodiments of the present invention is illustrated on the basis of exemplary resulting scheduling sequences.

[Example case 1]

In case 1, it is assumed that the first slave entity SN1 has assigned a higher priority than the second slave entity SN2. In accordance with the embodiments illustrated in FIG. 8, the scheduling period (Tᵢ₊₁−Tᵢ) is for instance set to 10 ms (milliseconds). Further, the first slave entity SN1 has for instance a communication period T_{C1}=10 ms (T_{C1}: communication period of first slave entity SN1, which may for instance be necessary to communicate a complete set of data between the first slave entity SN1 and any counterpart network entity for enabling to carry out of a specific application) and second slave entity SN2 has for instance a communication period of time T_{C2}=12 ms (T_{C2}: communication period of slave entity SN2, which may for instance be necessary to communicate a complete set of data between the first slave entity SN1 and any counterpart network entity for enabling to carry out of a specific application).

It should be further assumed that both slave entities have requested for having allocated right to communicate data (cf also FIG. 7 and description referring thereto) before T=0 ms in order to have allocated medium resources for its next repetition periods T_{R1}, and T_{R2}. This means that the repetition periods T_{R1}, T_{R2} of both slave entities SN1, SN2 is assumed to start at T=0 ms. In accordance with the priority levels of the slave entities, the first slave entity SN1 completes in the first scheduling period (0 ms to 10 ms) its data communication. Due to first slave entity's higher priority data communication task of the second slave entity SN2 has to be postponed until the first slave entity SN1 has completed its data communication task. For instance, data communication task of the first slave entity SN1 is completed after the first scheduling period. Then, the second slave entity SN2 has allocated right to communicate data by the scheduler and communicates data during the second schedule period (10 ms to 20 ms) over the intra-body communication network. Even when now assuming that the first slave entity SN1 raises again an additional interrupt (during the second scheduling period) requesting for taking over right to communicate data, the right to communicate to passed to the first slave entity SN1 because of the higher priority assigned to the first slave entity SN1 and independent of whether the data communication of the second slave entity SN2 is completed or not and impendent of whether the data communication of the second slave entity SN2 should be completed within a defined deadline period.

According to the example embodiments illustrated in FIG. 8, the data communication of the first slave entity SN1 has a deadline period T_{D1}=20 ms and the data communication of the second slave entity SN2 has a deadline period T_{D2}=25 ms.

When again referring to case 1 illustrated in FIG. 8, the second slave entity SN2 can obtain right to communicate during fourth scheduling period (30 ms to 40 ms) at the earliest. During third scheduling period (20 ms to 30 ms) the first slave entity SN1 has acquired right to communicate data and makes use thereof for data communication over the intra-body communication network. Hence, even if the scheduler allocates right to communicate data to the second slave entity SN2 during the fourth scheduling period, the deadline of the second slave entity SN2, which is for instance T_{D2}=25 ms herein, is missed because the second slave entity SN2 requires the communication period T_{C2}=12 ms for communicating a complete set of data, which communication period T_{C2}=12 ms is partitioned into the second scheduling period (10 ms to 20 ms) having a length of 10 ms and at least the first 2 millisecond of the fourth scheduling period (30 ms to 40 ms). Hence, the complete set of data of the second slave entity SN2 is communicated after 32 ms at the earliest in this example. When now calculating the response time Tᵣₑₛ₂ for the data communication of the second slave entity SN1, which starts at T=0 ms in accordance with the aforementioned assumption that the repetition period T_{R2} starts at T=0 ms, a response time Tᵣₑₛ₂=32 ms results. However, the deadline period of the second slave entity SN2 has been defined to T_{D2}=25 ms. Hence, the deadline period of the second slave entity SN2 is missed.

[Example Case 2a]

In case 2a, it is assumed that the second slave entity SN2 has assigned a higher priority than the first slave entity SN2. Further, the scheduling period, communication periods and deadline periods as defined with reference to case 1 should likewise apply in this example case. It should be further assumed that both slave entities have requested for having allocated right to communicate data (cf also FIG. 7 and description referring thereto) before T=0 ms. In accordance with the priority levels of the slave entities, the second slave entity SN2 completes in the first scheduling period (0 ms to 10 ms) its data communication. Due to second slave entity's higher priority data communication task of the first slave entity SN1 has to be postponed until the second slave entity SN2 has completed its data communication task. For instance, data communication task of the second slave entity SN2 is completed after the second scheduling period in accordance with the communication period T_{C2}, which requires at least 2 ms of the second scheduling period in addition. Then, the first slave entity SN1 is allocated right to communicate data by the scheduler and communicates data during the third schedule period (20 ms to 30 ms) over the intra-body communication network.

Hence, even if the scheduler allocates right to communicate data to the first slave entity SN1 during the third scheduling period, the deadline of the first slave entity SN1 (T_{D2}=25 ms as assumed herein) is missed because the second slave entity SN2 has made use of the first and second scheduling periods (0 ms to 20 ms) to meet the required communication period T_{C2}=12 ms for communicating a complete set of data, which communication period T_{C2}=12 ms is partitioned into the first scheduling period (0 ms to 10 ms) having a length of 10 ms and the at least the first 2 millisecond of the second scheduling period (10 ms to 20 ms). Hence, the complete set of data of the first slave entity SN1 is communicated after a response time Tᵣₑₛ₁=30 ms at the earliest in this example. Hence, the deadline period T_{D1}=20 ms (<Tᵣₑₛ₁) of the first slave entity SN1 is missed.

[Example Case 2b]

In case 2b, which substantially corresponds to case 2a including in particular priorities of the slave entities, communication periods and deadline periods, the scheduling period may be adapted to a shorter period for instance equal to 1 ms.

In analogy to case 2a, it should be assumed that both slave entities have requested for having allocated right to communicate data (cf. also FIG. 7 and description referring thereto) before T=0 ms. In accordance with the priority levels of the slave entities, the second slave entity SN2 completes in the first set of scheduling periods (0 ms to 10 ms) its data communication. Due to second slave entity's higher priority data communication task of the first slave entity SN1 is postponed until the second slave entity SN2 has completed its data communication task independent of any number of interrupts raised by the lower prioritized first slave entity SN1.

Data communication task of the second slave entity SN2 is completed at T=12 ms in correspondence with the communication period T_{C2}=12 ms. This means that the communication of the second slave entity has been performed during the first 12 scheduling periods (each of which has a duration in time of 1 ms). Then, the first slave entity SN1 is allocated right to communicate data by the scheduler and communicates data during the second set of schedule periods (12 ms to 22 ms) over the intra-body communication network.

Consequently, the effective response time Tᵣₑₛ₂ of the second slave entity SN2 with regard to the second slave entity's repetition period T_{R1}=25 ms starting at T=0 ms results in Tᵣₑₛ₂=12 ms, which meets the requirements of the individual communication period T_{C2}=12 ms at the aforementioned repetition period T_{R2}=25 ms and the deadline period of T_{D2}=25 ms.

Further, the effective response time Tᵣₑₛ₁ of the first slave entity SN1 with regard to the first slave entity's repetition period T_{R2}=20 ms starting at T=0 ms results in Tᵣₑₛ₁=22 ms, which does not meet the requirements of the individual communication period T_{C1}=10 ms at the aforementioned repetition period T_{R1}=20 ms and the deadline period of T_{D1}=20 ms.

The first slave entity SN1 will be granted to right to communicate by the scheduler for the next set of scheduling periods (22 ms to 25 ms) because its next repetition period T_{R1}=20 ms has already been started at T=20 ms. At T=25 ms, the next repetition period T_{R2}=25 ms of the second slave entity SN2 starts in turn. The second slave entity SN2 is prioritized over the first slave entity SN1, which means that the scheduler allocates right to communicate data to the second slave entity SN2 for the set of next 12 scheduling periods (starting from T=25 ms to T=37 ms) in correspondence with the second slave entity's communication period T_{C2}=12 ms. Because of the passing the right to communicate from first entity SN1 to second slave entity SN2 at T=25 ms, the first entity SN1 has only partially completed a communication interval of T=3 ms of its total communication period T_{C1}=10 ms. Therefore, the right to communicate data is allocated at T=37 ms (end of the communication of the higher prioritized second slave entity SN2) to first slave entity SN1 for a set of 7 scheduling periods (T=37 ms to T=44 ms).

Consequently, the effective response time Tᵣₑₛ₂ of the second slave entity SN2 with regard to the second slave entity's repetition period T_{R1}=25 ms starting at T=25 ms results in 12 ms, which meets the requirements of the individual communication period T_{C2}=12 ms at the aforementioned repetition period T_{R2}=25 ms and the deadline period of T_{D2}=25 ms.

Further, the effective response time Tᵣₑₛ₁ of the first slave entity SN1 with regard to the first slave entity's repetition period T_{R1}=20 ms starting at T=20 ms results in Tᵣₑₛ₁=24 ms, which does not meet the requirements of the individual communication period T_{C1}=10 ms at the aforementioned repetition period T_{R1}=20 ms and the deadline period of T_{D1}=20 ms.

It should be noted that the shortened scheduling period of 1 ms may likewise be applied to example case 1, in which first slave entity SN1 is prioritized over the second slave entity SN2. However, those skilled in the art will appreciate immediately on the basis of the detailed description above that the scheduling sequence illustrated in FIG. 8 will not be effected by the shortened scheduling period. The data communication of the second slave entity SN2 will likewise miss the deadline

[Example Case 3]

In case 3, an exemplary scheduling sequence in accordance with the earliest deadline first scheduling scheme is presented. As aforementioned, the first slave entity SN1 should be allowed to make use of the individual communication period T_{C1}=10 ms (T_{C1}: communication period of slave entity SN1) for communicating data over the intra-body communication network at the individual repetition period T_{R1}=20 ms. The second slave entity SN2 should be allowed to make use of the individual communication period T_{C2}=12 ms (T_{C2}: communication period of slave entity SN2) for communicating data over the intra-body communication network at the individual repetition period T_{R2}=25 ms. This means that the data communication of the first slave entity SN1 has the deadline period T_{D1}=20 ms and the data communication of the second slave entity SN2 has the deadline period T_{D2}=25 ms. The scheduling period is again assumed being shortened to T=1 ms.

Again, it should be assumed that both slave entities SN1 and SN2 have requested for having allocated right to communicate data (cf also FIG. 7 and description referring thereto) before T=0 ms and both repetition periods T_{R1}, T_{R2} start at T=0 ms. According to an embodiment of the present invention, the slave entity having the shortest deadline will be assigned the highest priority. Starting from this scheduling scheme outline, independent of the priority attributes assigned to the slave entities SN1 and SN2, the scheduler allocates right to communicate data to the first slave entity SN1 having a shorter deadline (T_{D1}=20 ms) than the competing second slave entity SN2 (T_{D2}=25 ms). This means that the scheduler allocates right to communicate data to slave entity SN1 in the first scheduling intervals (0 ms to 10 ms) corresponding to its individual communication period T_{C1}=10 ms. Then, the right to communicate data is allocated in the next second scheduling intervals (10 ms to 22 ms) to second slave entity SN2. The first slave entity SN1 has been allocated the right to communicate data for the required communication period T_{C1}=10 ms and the next repetition period T_{R1 ‘}of first slave entity SN1 (starting at T=20 ms) has not been started at the current moment in time (T=10 ms). Hence, the second slave entity SN2 has currently the shortest deadline period T_{D2}=25 ms because of lacking any network entity competing for right to communicate data. Hence, the right to communicate data is allocated to second slave entity SN2 for a duration of 12 ms, which corresponds to its individual communication period T_{C2}=12 ms.

It should be noted that the scheduler may substantially allocate the right to communicate to the different network entities without observance of predefined starting points in consequence to predefined scheduling periods having equal duration in time. Therefore, the duration of time, which is allocated by the scheduler to one of the network entities for data communication over the intra-body network, is designated in this example as interval in contrast to the scheduling period as defined above. Those skilled in the art will understand that this distinguishing between scheduling period and scheduling interval is for the sake of a more intelligible description. However, it should be noted that the aforementioned scheduling period should not be understood as being limited to a predefined period having a fixed duration. The scheduling period may also be subjected to any adaptation or alteration by the scheduler taking account of varying constraints. The continuous allocation of starting points as outlined above allows for commencing of data communication of a network entity having right to communicate without respect to any time grid. This continuous allocation of starting points may be realized on the basis of a quasi-continuous allocation. Such a quasi-continuous allocation may be obtained by the use of (very) short scheduling periods having a predefined and preferably constant length. The shorter the scheduling periods the closer is the quasi-continuous allocation to a continuous allocation.

Consequently, the effective response time Tᵣₑₛ₁ of the first slave entity SN1 with regard to the first illustrated repetition period T_{R1}=20 ms starting at T=0 ms results in Tᵣₑₛ₁=10 ms, which meets the requirements of the individual communication period T_{C1}=10 ms at the aforementioned repetition period T_{R1}=20 ms and the deadline period of T_{D1}=20 ms.

Further, the effective response time Tᵣₑₛ₂ of the second slave entity SN2 with regard to the first illustrated repetition period T_{R2}=25 ms starting at T=0 ms results in Tᵣₑₛ₂=22 ms, which meets the requirements of the individual communication period T_{C2}=12 ms at the aforementioned repetition period T_{R2}=25 ms and the deadline period of T_{D2}=25 ms.

Moreover, the scheduler allocates the right to communicate data for the next scheduling interval (starting at T=22 ms) to the first slave entity SN1 having again the shortest deadline because the next repetition period of the first slave entity SN1 has been started at T=20 ms (i.e. during communication of the second slave entity SN1 during the scheduling interval 10 ms to 22 ms) and the repetition period of second slave entity SN2 has not been lased at this point in time (T=22 ms). When reaching the point in time T=25 ms, the next repetition period of the second slave entity SN2 starts. This means that the right to communicate data is allocated in the next second scheduling interval (32 ms to 44 ms) to second slave entity SN2. The first slave entity SN1 has been allocated the right to communicate data for the required communication period T_{C1}=10 ms and the next repetition period of first slave entity (starting at T=40 ms) has not been started at the current moment in time (T=32 ms). Hence, the second slave entity SN2 has the shortest deadline period because of lack of any network entity competing for right to communicate data. Hence, the right to communicate data is allocated to second slave entity SN2 for a duration of 12 ms, which corresponds to its individual communication period T_{C2}=12 ms.

Consequently, the effective response time T′ᵣₑₛ₁ of the first slave entity SN1 with regard to the second illustrated repetition period T_{R1}=20 ms starting at T=20 ms results in T′ᵣₑₛ₁=12 ms, which meets the requirements of the individual communication period T_{C1}=10 ms at the aforementioned repetition period T_{R1}=20 ms and the deadline period of T_{D1}=20 ms.

Further, the effective response time T′ᵣₑₛ₂ of the second slave entity SN2 with regard to the second illustrated repetition period T_{R2}=25 ms starting at T=25 ms results in T′ᵣₑₛ₂=19 ms, which meets the requirements of the individual communication period T_{C2}=12 ms at the aforementioned repetition period T_{R2}=25 ms and the deadline period of T_{D2}=25 ms.

Frequency Domain

One of the fundamental scheduling concepts is operable in the frequency domain and allows for frequency domain scheduling. For the sake of explanation, following assumptions should be considered. All slave entities of the intra-body communications network should be time-synchronized, each slave entity has assigned a “frequency band” within which is can communicate over the intra-body communication network (and in particular with the host entity of the intra-body communication network). The term frequency band may be understood as a set of frequencies used for signal discrimination. The scheduler, which may be comprised by the master entity, assigns the complete set of frequency bands in accordance with the scheduling scheme to the respective slave entity for data communication of the intra-body network. The scheduler assigns the frequency bands in accordance with “time slices” or time quanta (also referred to above as scheduling periods), during which the network entity having right to communicate is allowed for communications over the intra-body communications network. Hence, aforementioned different time domain scheduling embodiments apply likewise.

The communication resources, i.e. the available frequency bands, should be in principle provided to that network entity, which is currently allowed for communication. As aforementioned, the term “communication of the network slave entity” should be understood as including in particular communication to the host entity, i.e. including communication into any of the two (download and upload) directions including communication originating at the network slave entity and terminating at the host entity and communication originating at the host entity and terminating at the network slave entity. However, the general term “network communication” should not be understood as being limited to communication with the host entity. The network slave entity, which is currently allowed for communication may likewise communicate data in a one-to-one communication task to anyone of the network entities or in a one-to-many communication task to several network entities thereof.

Frequency Domain Preemptive Scheduling

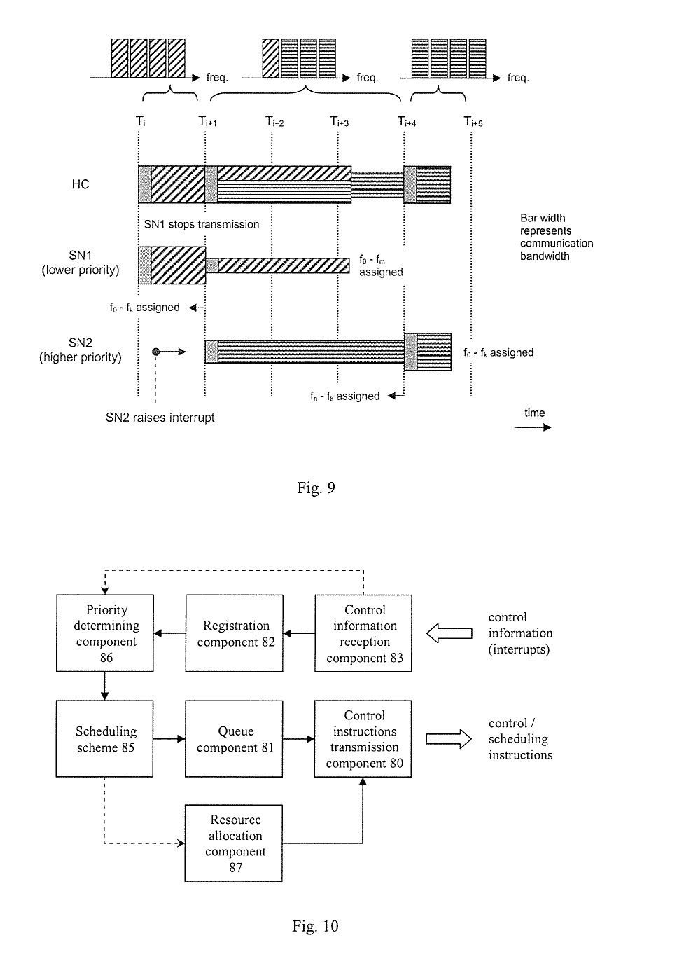

In a further embodiment, the scheduler may define several subsets of frequencies out of the frequency band, i.e. the totality of frequencies, which can be used for intra-body signal communication. The subsets of frequencies can be allocated to different slave entities inquiring for data communication over the intra-body communication network. The number of frequencies in the subsets may be determined by the priorities of the slave entities. This means that the scheduler allocates a subset of a first number of frequencies to a slave entity, which has a higher priority, and a subset of a second number of frequencies to a slave entity, which has a lower priority, wherein the first number is higher than the second number. An example embodiment of the aforementioned priority based frequency band allocation is illustratively depicted in FIG. 9.

According to the example embodiment shown in FIG. 9, it should be assumed that the first slave entity SN1 has a lower priority and the second slave entity SN2 has a higher priority. In the first scheduling period (Tᵢ to Tᵢ₊₁) the first slave entity SN1 has allocated a set of all frequencies (f₀ to fₖ) available for intra-body data communication over the network. The higher prioritized second slave entity SN2 raises an interrupt during the first slave entity SN1 has allocated right to communicate. The interrupt may be communicated to the scheduler through a common channel f_{c} (i.e. the interrupt is coded at a frequency or frequencies f_{c}, which is reserved and dedicated for exchanging control information over the intra-body communication network).

In accordance with the aforementioned time domain scheduling scheme embodiments, the right to communicate would be passed by the scheduler to the higher prioritized second slave entity SN2. The possibility of allocating subsets of frequencies results therein that the first slave entity SN1 has not necessarily to stop data communication. Instead, the scheduler defines two subsets of frequencies having different number of frequencies. The subset having the higher number of frequencies (f₀ to fₖ) is allocated to the higher prioritized second slave entity SN2. The subset having the lower number of frequencies (f₀ to fₘ) is allocated to the lower prioritized first slave entity SN1. Hence, the second slave entity SN2 will have the possibility to communicate data at a higher data rate than the first slave entity SN1. Once, the data communication task of the first slave entity SN1 is complete, the scheduler will allocate the total set of available frequencies (f₀ to fₖ) to the second slave entity SN2 starting with the next scheduling period (Tᵢ₊₄) provided there has not been raised an interrupt by a higher prioritized slave entity.

The aforementioned frequency band splitting and selective allocation may be applied in case a lower prioritized slave entity currently performs a data communication task, which should be allowed to be finished (at a lower data communication rate). Frequency splitting and selective allocation may or may not be applied in case a lower prioritized slave entity raises an interrupt requesting for right to communicate data during a higher prioritized slave entity currently performs a data communication task. In this case, the scheduler may grant right to communicate data after the higher prioritized slave entity has completed its data communication task. Alternatively, the scheduler takes away a number of frequencies from the higher prioritized slave entity and allocates these frequencies to the lower prioritized slave entity, wherein the scheduler considers the different priority in that the number of frequencies allocated to the lower prioritized slave entity is lower than the number of frequencies remaining allocated to the higher prioritized slave entity.

It should be noted that time domain scheduling schemes and frequency domain scheduling schemes may be combined for forming mixed scheduling schemes. In particular, time domain round robin and frequency domain preemptive scheduling schemes may be combined.

Although the aforementioned embodiments refer to slave entities subjected to the scheduling schemes operated by the scheduler comprised by the master entity, it should be understood that the master entity itself may be considered by the scheduler as a slave entity such that the master entity can also raises interrupts to request for right to communicate data over the intra-body communication network.

General Scheduler Embodiment and Operation

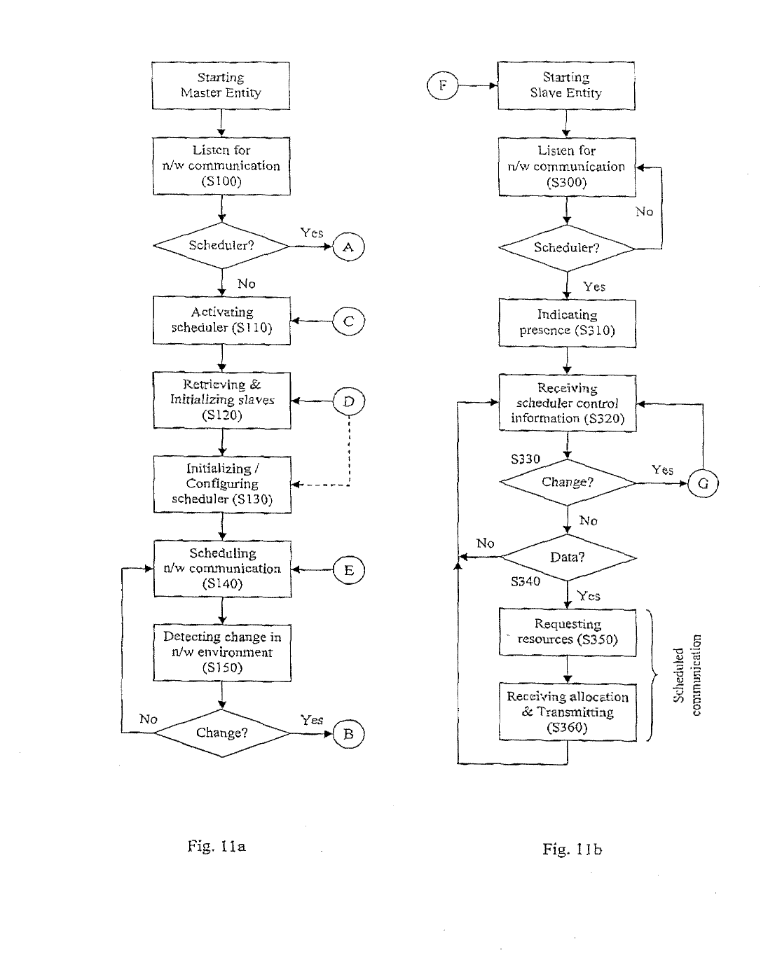

According to an embodiment of the present invention, the scheduler schematically illustrated on the basis of a block diagram in FIG. 10 comprises a control information reception component 83, a registration component 82, a priority determining component 86, a scheduling scheme 85, a queue component 81, and a control instruction transmission component 80.

The control information reception component 83 is configured to receive interrupts raised by the slave entities of the intra-body communication network requesting for right to communicate. The registration component 82 registers the received interrupts and the priority determining component 86 is configured to determine the priorities assigned to the slave entities. The registered interrupts of the slave entities and the priorities assigned to the slave entities, of which interrupts have been registered are supplied to the scheduling scheme, which is configured to determine a sequence in which the right to communicate data over the intra-body communication network have to be allocated to the slave entities having raised interrupts. The scheduling scheme operates in accordance with any scheduling scheme or mixed scheduling scheme according to an embodiment of the present invention.

The sequence in which the right to communicate data over the intra-body communication network have to be allocated to the slave entities is supplied to the queue component 81 configured for mainlining this sequence. The control instruction transmission component 80 is configured to finally transmit scheduling instructions to the slave entities in the intra-body communication network, which instructions cause the slave entities to perform their data communication tasks in the sequence as maintained in the queue component 81.

In addition, a resource allocation component 87 is provided in the scheduler according to an embodiment of the present invention, which resource allocation component 87 is configured to provide a set of communication resources, which can be partially allocated to several network entities. The resource allocation component 87 is apated to from a group of subsets of communication resources from total set of communication resources. The resource allocation component 87 is further configured to allocate the group of subsets of communication resources to a group of network devices at a given scheduling period and the right to communicate data over the intra-body communication network during the next scheduling period to the group of network devices having allocated the group of subsets of communication resources with the help of the control instruction transmission component 80.

The scheduler further comprises an initialization component (not shown), which is provided for starting the scheduler and initializing slave entities of the intra-body communication network such that the data communication of the slave entities is under control of the scheduler.

The operation of a scheduler comprised by a master entity will be described in more detail with reference to FIG. 11a illustrating schematically a flow diagram of an exemplary master entity according to an embodiment of the present invention.

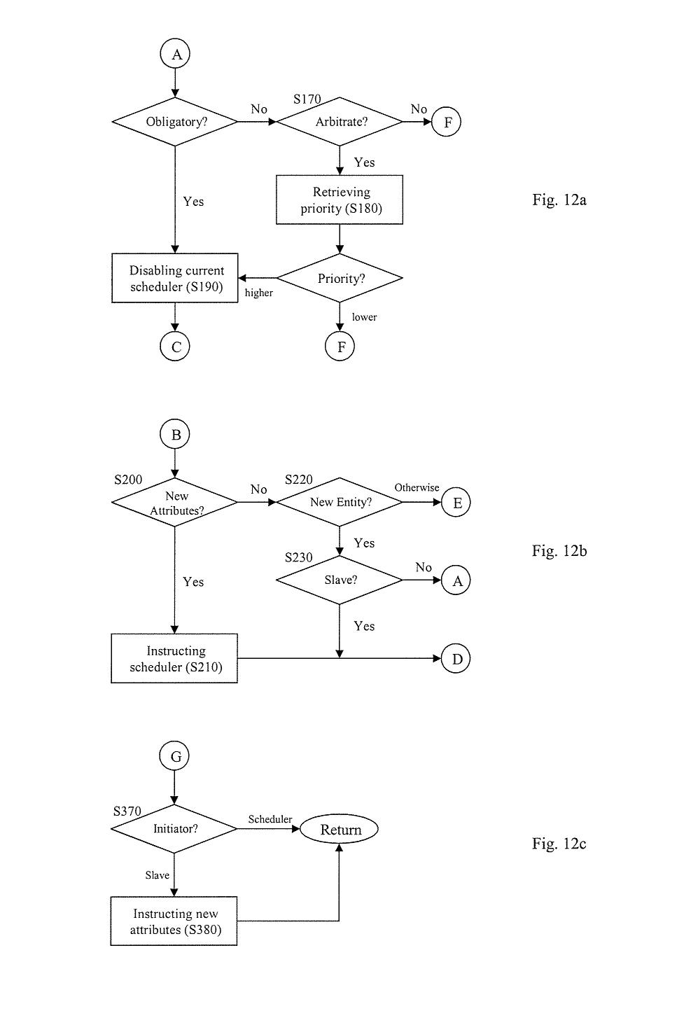

Upon starting of a network entity comprising a scheduler (i.e. a master entity) as illustratively directed in FIG. 10 and described in detail with reference thereto, the scheduler of the master entity has to verify whether data communication over the intra-body communication network is already under control of another scheduler because any network entity of the intra-body communication network may comprise a scheduler. Therefore, the scheduler listens in an operation S100 for any network activity over the intra-body network in order to determine whether a scheduler has already control over the network communication thereon. If there is not present any active scheduler of another master entity, the sequence branches to operation S110, in which the master entity activates its scheduler. The scheduler may for instance listen for control information expected to be exchanged over the intra-body communication network for a predefined and/or arbitrary time interval. In case the scheduler detects control information exchanged over the intra-body communication network the scheduler interrupts operation at the moment and the master entity procedure branches to operational sequence illustratively depicted in FIG. 12a and described in more detail below.

Upon scheduler's activation, the scheduler may retrieve information required for scheduling operation from the slave entities in an operation S120. Information may be retrieved from any slave entities, which are coupled to the intra-body communication network and are detected by the scheduler. The information retrieved from the slave entities may comprise one or more out of the set of slave entity attributes including for instance priority, communication period, repetition period, and/or deadline period of the slave entities. Thereupon, the scheduler may initialize the slave entities for instance by sending instructions to the slave entities instructing the slave entities to time-synchronize on a common time basis and to request for medium resource allocations from the newly activated scheduler and by sending information about the scheduling period.

Then, the scheduler may initialize and/or configured in an operation S130 the scheduling operation and scheme in accordance with the attributes of the slave entities and scheduler control information sent to the slave entities.

Upon successful initialization of the slave entities and the scheduler, the scheduler is enabled to exercise control over the communications on the intra-body communication network and schedules in an operation S140 the communication in accordance with any scheduling scheme according to an embodiment of the present invention. This means that the scheduler allocates medium resources in accordance with any scheduling scheme according to an embodiment of the present invention to the slave entities upon request received therefrom. The scheduling operation S140 may include sending scheduling information to the slave entities (about changed scheduling parameters such as scheduling period or to maintain/update time-synchronization of the slave entities).

On a regularly or arbitrary time basis, the scheduler may check for changes in the network environment of the intra-body communication network. Alternatively or in addition, the scheduler may be informed upon reception of change instructions about changes in the network environment of the intra-body communication network. Changes in the network environment may relate to a new network entity to be assigned to the scheduler, a new scheduler, which may take control over the communications on the intra-body communication network, new attributes (priority, communication period, repetition period, deadline period, etc.) of a previously slave entity already assigned to the scheduler and the like.

If the scheduler detects in an operation S150 any change in the network environment, which effects the scheduling operation, the master entity procedure braches to the operational sequence illustratively depicted in FIG. 12b and described in more detail below. Otherwise the operation flow returns to operation S140.

With reference to FIG. 12a, a further flow diagram according to an embodiment of the present invention is schematically illustrated. The operational sequence continues with branch point “A” upon detection of another scheduler exercising already control over the communications over the intra-body communication network.

In an operation S160, it may be checked whether the taking over of the scheduling operation by the scheduler of the newly activated master entity is obligatory. Such an obligatory take over of the scheduling operation may be for instance adequate in a medical use scenario, in which a body of a patient is provided with a plurality of physiological sensors, which data supplied by the sensors is collected in a central host device acting as master device during collecting of the data over the day. The collected data may be retrieved through a data communication interface (such as a wireless or wired interface including for instance USB, Bluetooth, etc.) to an external processing device (such as a desktop computer). The data communication interface may be further used for instant monitoring of the data supplied by the physiological sensors. In this case, when real-time monitoring through the external processing device should be performed, it may be adequate to pass control over the communications over the intra-body communication network to the external processing device enabling the external processing device for instance to prioritized sensor data of one or more physiological sensors.

In case the taking over of the scheduling operation by the scheduler of the newly activated master entity is obligatory, the currently active scheduler is deactivated by for instance sending a deactivation/disabling instruction thereto in an operation S190 and the master entity procedure continues with operation S110 for configuring the scheduling operation by the scheduler of the newly activated master entity.

In an operation S170, the scheduler intended for exercising control over the communications on the intra-body communication network may be negotiated between the scheduler currently active and the scheduler of the newly activated master entity. In an operation S180, information about the currently active scheduler may be retrieved. The scheduler/master device having a higher priority attribute may be the scheduler designated for performing scheduling operations. In case the scheduler of the newly activated master entity has a higher priority attribute than the currently active scheduler, the master entity procedure braches to operation S190, in which currently active scheduler is deactivated.

In case negotiation is not desired or the scheduler of the newly activated master entity has a lower priority, the master entity procedure stops, the scheduler is deactivated and the master entity registers as a “conventional” slave entity at the currently active scheduler to be allowed to participate in communications on the intra-body communication network. The master entity procedure continues with branch point “F”. The slave entity procedure according to an embodiment of the present invention will be described in more detail with reference to FIG. 11b.

With reference to FIG. 12b, a further flow diagram according to an embodiment of the present invention is schematically illustrated. The operational sequence continues with branch point “B” upon detection of change in the network environment of the intra-body communication network. In an operation S200, it is checked whether a slave entity informs about one or more new slave entity attributes (including priority, communication period, repetition period, deadline period, and the like). If one or more new slave entity attributes are received by the scheduler, the scheduler may be instructed in an operation S210 to reinitialize or adjust its operation to the one or more new attributes instructed by the slave entity. For instance, a slave entity has an alert message, which requires immediate communication (or at least as fast as possible). For instance, a physiological sensor sensing the heart beat of a patient may register abnormal measurement values. Such abnormal measurement may be communicated over the intra-body communication network at highest priority level in order to ensure immediate transmission. The master entity procedure continues with operation S120 (or operation S130) by reinitializing or adjusting the operation of the scheduler in accordance with the one or more new slave entity attributes.

In an operation S220, a new network entity may indicate its presence to the scheduler of the intra-body communication network. In case the new network entity is a master entity comprising a scheduler, the master entity procedure may branch to operation S160 in order to decide which scheduler should exercise control over the intra-body communication network. In case the new network entity is a slave entity, the master entity procedure continues with operation S120 (or operation S130) by reinitializing or adjusting the operation of the scheduler in accordance with the attributes of the new slave entity.

As a default operation, the operational sequence started at branch point “B” may continue with branch point “E” in that the operational sequence is continued with the network communication scheduling operation S140 depicted in FIG. 11a and described above with reference thereto.

The operation of a slave entity will be described in more detail with reference to FIG. 11b illustrating schematically a flow diagram of such an exemplary slave entity according to an embodiment of the present invention.

Upon starting of a network entity having slave entity properties, which may a slave entity or a master entity with or without activated scheduler, to allow the network entity to allocate medium resources for communication over the intra-body communication network, in an operation S300, the network entity listens for an activated scheduler exercising control over the communication on the intra-body communication network. In case a scheduler is not present, the network entity may continuously repeat the listening operation S300 until a scheduler is available in the network.

In operation S310, the network entity indicates its presence in the intra-body communication network to the scheduler, which causes the scheduler to register the indicating network entity as a new slave entity in the intra-body communication network. In addition, the network entity sends information about its properties and/or attributes (including in particular priority, communication period, repetition period, and deadline period) to the scheduler such that the scheduler can configure the scheduling operation taking account of the new slave entity. Upon registration at the scheduler, the slave entity receives scheduler control information (including in particular time-synchronization, scheduler address information, and scheduling period) in an operation S320. In an operation S330, the slave entity may check for changes in the environment of the intra-body communication network. Such changes in the environment may be effected by the slave entity itself or may be indicated by the scheduler as described with reference to the flow diagram illustrated in FIG. 12b according to an embodiment of the present invention. The changes in the environment may also include a disabling of a currently active scheduler and activating of a new scheduler as described above with reference to FIG. 12a schematically depicting a flow diagram according to an embodiment of the present invention. In case a change in the network environment should take place, the slave entity procedure continues with branch point “G”, which subsequent operational sequence is depicted in FIG. 12b showing a flow diagram according to an embodiment of the present invention. In an operation S137, it may be checked whether the change in the network environment such be effected by the slave entity itself or is caused by the scheduler. In the first case, the slave entity sends its one or more new attributes to the scheduler in an operation S380 causing the scheduler to re-configure in accordance with the new attributes. The operational sequence then returns to operation S320, in which the slave entity receives new scheduler control information. The instructing of the scheduler about mew slave entity new attributes may include a de-assigning of the slave entity from the scheduler such that the slave entity is not any more under the control of the scheduler. In the latter case, the operational sequence may continue directly with operation S320, in which the slave entity receives the new scheduler control information in response to the schedulers effected change in the network environment.

In an operation S340, the slave entity checks whether data to be communicated is present thereat. In case, there are not data present at the moment, the slave entity procedure branches to operation S320. Otherwise, the slave entity requests for medium resources for instance by raising an interrupt sent to the scheduler. Thereupon, the scheduler informs the slave entity about medium resources allocated for communicating the data at the slave entity, in an operation S360 and the slave entity makes use of the allocated medium resources to communicate the data present thereat. The operational sequence returns to operation S320 and repeats the core operational sequence of the slave entity procedure.

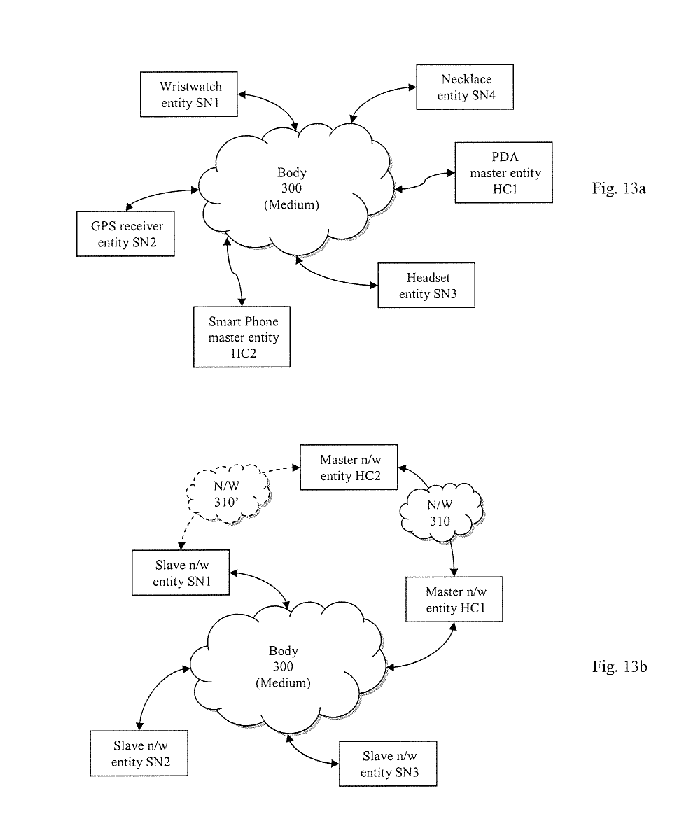

With reference to FIGS. 13a and 13b, two of the aforementioned cases are illustratively depicted according to embodiments of the present invention. FIG. 13a schematically depicts a block diagram illustrating an intra-body communication network having several slave entities SN1 to SN4 and two master entities HC1 ad HC2. In this case, either the master entity HC1 or master entity HC2 should be allowed to exercise control over the communication on the intra-body communication network. One of the master entities HC1 and HC2 may appoint itself as the master entity with active scheduler, one of the master entities HC1 ad HC2 may appoint itself as the master entity with deactivated scheduler, or the master entities HC1 ad HC2 may negotiate the active scheduler on the basis of priorities being attributed to the schedulers thereof FIG. 13b schematically depicts a block diagram illustrating an intra-body communication network having several slave entities SN1 to SN4 and a first master entity HC1 directly coupled to intra-body communication network and a second master entity HC2 indirectly coupled to the intra-body communication network through for instance the first master entity HC1 (shown in FIG. 13b with the help of a drawn through line) or any other network entity (shown in FIG. 13b with the help of a dashed line) of the intra-body communication network. The second master entity HC2 indirectly coupled to the intra-body communication network may be indirectly coupled through any further network 310 or 310′ inter-coupling the second master entity HC2 to the network entity (e.g. the master entity HC1 or the slave entity SN1). The first or the second master entity HC1, HC2 may comprise the active scheduler, which may be determined or negotiation in accordance with the aforementioned principles.

Use Cases

The inner-body communication network allows for various different types of applications and use cases. In the following, three exemplary envisaged use cases should be presented in brief.

[Case: Easy Input]

For device with poor input system like as a wristwatch device, it is cumbersome to a user to input long sentence or to execute a delicate command. There have been many input assistance systems proposed before, but basically the proposed assistance systems need extra mechanical input means or high-advanced software, which in turn requires high computational power. The application proposed herein realizes an easier input without any hardware/software preparation. A sensor, which can be for instance mounted on a ring to be put on a finger, is adapted to detect and register the shape of objects, which are touched by the finger carrying the ring mounted sensor. The sensor may be an imaging sensor. Different objects are selected for registration and different characters may be assigned to these objects. Hence, a keymap can be defined on the basis of different register objects having assigned characters of the keymap. Thereafter, a user may input a character sequence by touching previously register object in the desired sequence. For instance ‘A’ may be assigned to a spoon, ‘B’ may be assigned to a fork, ‘C’ may be assigned to a knife, and the like. At each touching of an object, the character assigned thereto is retrieved form the keymap and communicated to the network entity expecting the user input sequence.

[Case: Fast Download]

The basic concept for enabling fast download of content from a remote network server (e.g. an internet server) is to share the download task among several inner-body network entities, which are enabled for communicating with the remote network device. First, the data requested for download is spitted into a number of pieces for instance upon pre-processing request communication between host computer of the intra-body network and the remote network server. Then, the pre-processing host computer communicates download commands to all available slave entities of the intra-body communication network, which are for instance able to set up an internet connection. Each of the instructed slave entity downloads a piece of the contents from the remote network server. Finally, the host device concatenates all pieces of the contents, which are received through the intra-body communication network from the slave entities. This application will make the most of available radio resources and realize a fast download by using several different internet connections. The slave entities may support different communication technologies for accessing the remote server including for instance Bluetooth or WiMax/WLAN data communications (IEEE 802.x).

[Case: Scene Reality]

The intra-body communication network is to be used in gaming for augmented reality. Slave entities are provided with environmental parameter from the host computer carrying out the gaming software. The environmental parameter provided to the slave entities may depend on a gaming condition and/or situation. Each slave entity is configured for operating a mechanical actuator in response to information provided by the host computer in order to improve the gaming experience and conveying a more realistic feeling to the player of the game. For instance, a slave entity may emulate a rifle-recoil by exciting vibrations around the wrist and by poking on the shoulder of the player.

From the forgoing description, it will be apparent that modifications can e made to the system without departing from the teaching of the present invention. Accordingly, the scope of the invention is only to be limited as necessarily by the accompanying claims.

1. Method, comprising:
registering at a scheduler network entities of an intra-body communication network having raised interrupts to obtain right to communicate data over the intra-body communication network;
queuing at the scheduler the network entities in accordance with priorities of the network entities; and
allocating by the scheduler right to communicate data over the intra-body communication network during the next scheduling period to the next network entity in the queue.

2. Method according to claim 1, comprising:
queuing the network entities having same priorities in a cyclic repetition scheme such that the right to communicate data over the intra-body communication network is allocated to that network entity out of the group of network entities having same priorities, which has waited for the longest time.

3. Method according to claim 1, comprising:
retrieving deadline periods of communication tasks to be performed by registered network entities; and
queuing the network entities in accordance with the deadline periods.

4. Method according to claim 1, comprising:
providing a set of communication resources, wherein the set of communication resources can be partially allocated to several network entities;
forming a group of subsets of communication resources from total set of communication resources;
allocating the group of subsets of communication resources to a group of network devices at the same time; and
allocating the right to communicate data over the intra-body communication network during the next scheduling period to the group of network devices having allocated the group of subsets of communication resources.

5. Method according to claim 4, wherein the subsets of the groups of subsets of communication resources are formed in accordance with the priorities of the network devices of the group of network devices to which the groups of subsets of communication resources will be allocated.

6. Method according to claim 1, wherein the priority of a network entity can be modified by the scheduler controlling scheduling of data communication over the intra-body communication network.

7. Method according to claim 1, wherein the scheduling period can be modified by the scheduler controlling scheduling of data communication over the intra-body communication network.

8. Computer program product stored on a computer-readable medium comprising program code, which when carried out by at a processing device, allowing for performing the operations of:
registering network entities of an intra-body communication network having raised interrupts to obtain right to communicate data over the intra-body communication network;
queuing the network entities in accordance with priorities of the network entities; and allocating right to communicate data over the intra-body communication network during the next scheduling period to the next network entity in the queue.

9. Computer program product according to claim 8, comprising program code allowing for performing the further operations of:
queuing the network entities having same priorities in a cyclic repetition scheme such that the right to communicate data over the intra-body communication network is allocated to that network entity out of the group of network entities having same priorities, which has waited for the longest time.

10. Computer program product according to claim 8, comprising program code allowing for performing the further operations of:
retrieving deadline periods of communication tasks to be performed by registered network entities; and
queuing the network entities in accordance with the deadline periods.

11. Computer program product according to claim 8, comprising program code allowing for performing the further operations of:
providing a set of communication resources, wherein the set of communication resources can be partially allocated to several network entities;
forming a group of subsets of communication resources from total set of communication resources;
allocating the group of subsets of communication resources to a group of network devices at the same time; and
allocating the right to communicate data over the intra-body communication network during the next scheduling period to the group of network devices having allocated the group of subsets of communication resources.

12. Computer program product according to claim 11, wherein the subsets of the groups of subsets of communication resources are formed in accordance with the priorities of the network devices of the group of network devices to which the groups of subsets of communication resources will be allocated.

13. Computer program product according to claim 8, wherein the priority of a network entity can be modified by the scheduler controlling scheduling of data communication over the intra-body communication network.

14. Computer program product according to claim 8, wherein the scheduling period can be modified by the scheduler controlling scheduling of data communication over the intra-body communication network.

15. Scheduling module, comprising:
a registration component configured for registering network entities of an intra-body communication network having raised interrupts to obtain right to communicate data over the intra-body communication network;
a queue component configured for queuing the network entities in accordance with priorities of the network entities; and
an allocation component configured for allocating right to communicate data over the intra-body communication network during the next scheduling period to the next network entity in the queue.

16. Scheduling module according to claim 15, comprising:
the queue component configured for queuing the network entities having same priorities in a cyclic repetition scheme such that the right to communicate data over the intra-body communication network is allocated to that network entity out of the group of network entities having same priorities, which has waited for the longest time.

17. Scheduling module according to claim 15, comprising:
a retrieving component configured for retrieving deadline periods of communication tasks to be performed by registered network entities; and
queuing the network entities in accordance with the deadline periods.

18. Scheduling module according to claim 15, comprising:
a set of communication resources, wherein the set of communication resources can be partially allocated to several network entities;
a forming component configured for forming a group of subsets of communication resources from total set of communication resources;
the allocation component configured for allocating the group of subsets of communication resources to a group of network devices at the same time; and
the allocation component configured for allocating the right to communicate data over the intra-body communication network during the next scheduling period to the group of network devices having allocated the group of subsets of communication resources.

19. Scheduling module according to claim 18, wherein the subsets of the groups of subsets of communication resources are formed in accordance with the priorities of the network devices of the group of network devices to which the groups of subsets of communication resources will be allocated.

20. Scheduling module according to claim 15, wherein the priority of a network entity can be modified by the scheduler controlling scheduling of data communication over the intra-body communication network.

21. Scheduling module according to claim 15, wherein the scheduling period can be modified by the scheduler controlling scheduling of data communication over the intra-body communication network.

22. Scheduling module, comprising:
means for registering network entities of an intra-body communication network having raised interrupts to obtain right to communicate data over the intra-body communication network;
means for queuing the network entities in accordance with priorities of the network entities; and
means for allocating right to communicate data over the intra-body communication network during the next scheduling period to the next network entity in the queue.

23. Intra-body communication network system, comprising:
plural network entities; and
a scheduling module, comprising:
a registration component configured for registering network entities of the intra-body communication network having raised interrupts to obtain right to communicate data over the intra-body communication network;
a queue component configured for queuing the network entities in accordance with priorities of the network entities; and
an allocation component configured for allocating right to communicate data over the intra-body communication network during the next scheduling period to the next network entity in the queue.
